(19) United States
(12) Patent Application Publication
(10) Pub. No.: US 2017/0159664 A1
(43) Pub. Date: Jun. 8, 2017

(54) Direct Drive Ceiling Fan

(71) Applicant: Phase Industrial Design Ningbo Co., Ltd., Ningbo (CN)

(72) Inventor: Hung DU, Reisterstown, MD (US)

(73) Assignee: Phase Industrial Design Ningbo Co., Ltd., Ningbo (CN)

(21) Appl. No.: 14/961,912

(22) Filed: Dec. 8, 2015

(51) Int. Cl. F04D 25/08; H02K 1/27; F04D 29/053; H02K 9/22; F04D 25/06; H02K 3/28; H02K 5/04

(52) U.S. Cl. CPC F04D 25/088; H02K 3/28; H02K 1/2706; H02K 5/04; H02K 9/22; F04D 25/06; F04D 29/053

(57) ABSTRACT

A direct drive ceiling fan is described that includes at least one blade and a permanent magnet motor (e.g., PMSM) as a driving source. The permanent magnet motor includes a stator with a 45 to 90 slot construction and multiple stator winding coils and the rotor assembly includes a permanent magnet that has from 50 to 80 magnetic poles. The coils are wound according to a symmetric winding pattern that is selected based on the numbers of slots and poles used in the motor. The resulting motor produces near zero to zero radial forces (Fx and Fy) during operation of the fan.

### BACKGROUND OF THE INVENTION

The present invention relates to ceiling fans and more particularly direct drive ceiling fans. More specifically, the present invention relates to direct drive ceiling fans which are especially useful in high volume air flow ranges.

Current high volume fans, such as ones having an air flow range of over 300,000 CFM, due to their size, for instance 24 foot blade models, are used in the commercial industry such as in poultry processing and the like. However, when the ceiling fans become large and deal with high volume air flow ranges of over 50,000 CFM, the ability to drive these fans directly without any gears; hence without gear noise, and without motor noise due to vibrations of the motor can be a technical challenge. It appears that the current industry came to the conclusion that such large fans would not be capable of being driven by direct drive permanent magnet motors, such as a Permanent-Magnet Synchronous Motor (PMSM), in a stable non-vibrational way as done with smaller residential fans. Instead, these industrial sized high volume fans are driven for instance by gear technology which includes a gear box. While smaller commercial fans, for instance ones that are 8 to 14 foot in diameter, have been made using direct drive motor technology, there appears to be an understanding in the technology that fans larger than this size, which create high volume air movement, such as on the order of over 50,000 CFM or over 100,000 CFM, have not been possible with gearless permanent magnet motor technology. In lieu of gear box technology, to drive high volume large fans, some in the industry have used AC Induction Motor (ACIM) technology as a choice due to its proven design and acceptance. However, both ACIM and gear box systems are large, heavy, and expensive. In addition, ACIM and gear box systems are not popular in public places due to their aesthetics and due to their noise when operated. An alternative solution to the ACIM and gearbox technology is direct drive Transverse Flux Motor (TFM) technology where the main principle of the transverse flux motor is the use of a magnetic flux through the stator core which requires magnetic circuits and a very complicated and expensive geometry for the TFM motor. While the TFM motor has simple stator windings, it does require two to three times more active permanent magnet material, two to three times more magnet material cost, and a complex 3-D stator lamination geometry.

Considering the type of technology that is commercially used for industrial ceiling fans, such as ones that are 14 to 24 foot, there has been a need to make it possible for the use of PMSM technology. If one could find a solution to house such technology in large industrial ceiling fans, this would be quite preferred since it is aesthetically more acceptable and produces high torque at low speed without the need of using any gear box; hence eliminating the gear noise. Also, the use of PMSM technology is a very cost effective choice since the rotor construction is simpler, the winding pattern of the stator is very easy to manufacture, and the material utilization is more cost efficient. In addition, a PMSM has a higher power-to-weight ratio which is capable of producing more than twice the power but in half of the size and weight compared to ACIM and gear box technology. Thus, there is a need in the industry to effectively use PMSM technology that can operate as 14 foot to 24 foot ceiling fans and that provides the same blade and operating torque as current fans, but at twice the speed or twice the power. Further, there is a need to provide a low cost alternative to the considerably more expensive ACIM and gear box systems and direct drive TFM systems used in some industrial fans.

### SUMMARY OF THE PRESENT INVENTION

A feature of the present invention is to provide a high volume-low speed direct drive ceiling fan for such applications as air flow ranges from 50,000 CFM to 350,000 CFM.

A further feature of the present invention is to provide a direct drive ceiling fan which can use a permanent magnet motor and can operate with zero radial forces even when high volume air flow applications are used.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a direct drive ceiling fan. The direct drive ceiling fan includes at least one blade (e.g., one blade, two blades, three blades, four blades, five blades, from six to twenty blades) and also includes a permanent magnet motor, such as a Permanent-Magnet Synchronous Motor (PMSM), as the driving source for the ceiling fan. The permanent magnet motor is mounted on a shaft and includes a stator having an axis. The permanent magnet motor has a 45 to 90 slot construction and has multiple stator winding coils having a symmetrical winding pattern on the stator. A rotor assembly that is rotatable mounted on the shaft includes a circular casing with a periphery. Permanent magnets are present on the periphery and interact with the stator winding coils of the stator. The permanent magnet has from 50 to 80 magnetic poles. Also, the ceiling fan has a motor controller that is used to energize the stator winding coils such that the motor controller changes current of the stator windings to produce magnetic fields required to drive the rotor assembly and the at least one blade.

The present invention further relates to the direct drive ceiling fan as described above which has an air flow range of from about 50,000 CFM to about 350,000 CFM.

It is to be understood that both the foregoing general description and the following detailed description are exemplary and explanatory only and intended to provide a further explanation of the present invention, as claimed.

### BRIEF DESCRIPTION OF THE DRAWINGS

The present invention can be even more fully understood with the reference to the accompanying drawings which are intended to illustrate, not limit, the present invention.

FIG. 1 is a side, cross-sectional view of a ceiling fan according to an exemplary embodiment of the present invention.

FIG. 2A is a top view of a stator body that can be used in a ceiling fan of the present invention.

FIG. 2B is an enlarged sectional view taken along circle B of FIG. 2A.

FIG. 2C is side view of the stator body shown in FIGS. 2A and 2B.

FIG. 3A is a top view of a rotor that can be used, together with the stator body shown in FIGS. 2A-2C, as components of a permanent magnet motor, such as a PMSM.

FIG. 3B is a side, cross-sectional view taken along line B-B in FIG. 3A.

FIG. 3C is an enlarged sectional view taken along circle C in FIG. 3B.

FIG. 3D is an enlarged sectional view taken along circle D in FIG. 3A.

FIG. 4A is a top view of a winding stator of a permanent magnet motor, such as a PMSM, including coils formed in a symmetrical winding pattern according to an exemplary embodiment of the present invention.

FIG. 4B is an enlarged sectional view of a section of the winding stator shown in FIG. 4A.

FIG. 4C is a top view of the winding stator shown in FIGS. 4A and 4B surrounded by a seventy-pole (70-pole) rotor.

FIG. 4D is a graph comparing the motor torque with radial forces Fx and Fy generated by a permanent magnet motor, such as a PMSM, running at 50 RPM having the winding stator and rotor shown in FIGS. 4A-4C.

FIG. 5A is a top view of a winding stator of a permanent magnet motor, such as a PMSM, including coils formed in a symmetrical winding pattern according to an exemplary embodiment of the present invention.

FIG. 5B is a top view of the winding stator shown in FIG. 5A surrounded by a seventy-pole (70-pole) rotor.

FIG. 5C is a graph comparing the motor torque with radial forces Fx and Fy generated by a PMSM running at 50 RPM having the winding stator and rotor shown in FIGS. 5A and 5B.

FIG. 6A is a top view of a winding stator of a permanent magnet motor, such as a PMSM, including coils formed in a symmetrical winding pattern according to an exemplary embodiment of the present invention.

FIG. 6B is a top view of the winding stator shown in FIG. 6A surrounded by a seventy-pole (70-pole) rotor.

FIG. 6C is a graph comparing the motor torque with radial forces Fx and Fy generated by a permanent magnet motor, such as a PMSM, running at 50 RPM having the winding stator and rotor shown in FIGS. 6A and 6B.

FIG. 7 is a graph showing the voltage per rpm constant (Ke) relative to the number of turns of the motor for a 750-watt 63S70P outer rotor permanent magnet motor, such as a PMSM, as shown in and described in connection with FIGS. 4A-4D.

FIG. 8 is a front prospective view of one example of a permanent magnet motor of the present invention.

FIG. 9 is an enlarged sectional view of the permanent magnets and metal ring that can be used in the present invention.

FIG. 10 is a top view of a winding stator of a PMSM including coils formed in an asymmetrical winding pattern as a comparative example.

FIG. 11. is a graph comparing the motor torque with radial forces Fx and Fy generated by the PMSM of FIG. 10, running at 50 RPM with the asymmetric winding pattern.

### DETAILED DESCRIPTION OF THE PRESENT INVENTION

The present invention relates to a direct drive ceiling fan having at least one blade and a permanent magnet motor as a driving source for the ceiling fan. The permanent magnet motor can be a Permanent-Magnet Synchronous Motor (PMSM). The motor is mounted on a shaft and comprises a stator having an axis, a 45 to 90 slot construction, and multiple stator winding coils having a symmetrical winding pattern on the stator. The permanent magnet motor includes a rotor assembly rotatably mounted on the shaft and comprising a circular casing having a periphery. The rotor can be an outer rotor design or an inner rotor design. A permanent magnet is present on the periphery and interacts with the stator winding coils of the stator. The permanent magnet can have from 50 to 80 magnetic poles.

A motor controller is used to energize the stator winding coils and the motor controller changes the current of the stator windings to produce magnetic fields useful to drive the rotor assembly and the at least one blade.

Each coil of the multiple stator winding coils can have from 30 turns to 150 turns per coil, for example, from about 40 turns to about 120 turns or from about 50 turns to about 110 turns per coil. The turns per coil are generally the same per coil in the stator. The turns per coil can be above or below these preferred number ranges.

The direct drive ceiling fan can produce various air flows. For instance, the ceiling fan can have the size and power to provide an air flow in the range of from about 50,000 CFM to about 350,000 CFM, such as from about 75,000 CFM to about 300,000 CFM, or 100,000 CFM to about 250,000 CFM.

The blades present on the ceiling fan can be from 1 to 20, such as from 3 to 12, or from 4 to 6. The blade length is generally from 6 ft to 24 ft, such as 8 ft to 20 ft.

The direct drive ceiling fan can include a stator and rotor having a combination of slots and poles and phases such that the value of q is less than 1, such as less than 0.5 in the equation:

$$q = ( \frac{\# of slots}{\# of magnetic poles} ) \div ( number of Phases )$$

The q can be, for instance, 2/5, 2/7, 3/7, 3/8, 3/10, or 3/11. q can range, for instance, from 0.9 to 0.2 or from 2/5 to 3/11, or from 0.35 to 0.8, or from 0.3 to 0.7, or from 0.3 to 0.5. Generally, the number of phases for this equation is 3.

When turned on, the permanent magnet motor such as the PMSM can operate the ceiling fan with zero radial forces (Fx, Fy) or near zero radial forces (Fx, Fy) (e.g., less than 10 N, such as less than 5 N or less than 2.5 N or less than 1 N, or less than 0.5 N for either Fx and/or Fy). For example, Fx can be less than 1 N or less than 0.5 N or less than 0.25 N and Fy can be less than 10 N or less than 5 N or less than 1 N.

The present invention also relates to a direct drive ceiling fan having a permanent magnet motor such as a PMSM, comprising a stator having a 45 to 90 slot construction, a rotor assembly comprising from 50 to 80 magnetic poles, and that uses a winding pattern as follows: . . . /C′A/A′A′/AB′/BB/B′C/C′C′/CA′/AA/A′B/B′B′/BC′/CC/ . . . , where A′, B′, and C′ indicate a reverse in coil winding direction. Each “/” represents a tooth in the stator.

The present invention also relates to a direct drive ceiling fan comprising a permanent magnet motor such as a PMSM, comprising a stator having a 45 to 90 slot construction, a rotor assembly comprising from 50 to 80 magnetic poles, and that uses a winding pattern as follows: . . . /C′A/A′A′/AA/A′B/B′B′/BB/B′C/C′C′/CC/ . . . , where A′, B′, and C′ indicate a reverse in winding direction.

The present invention also relates to a direct drive ceiling fan comprising a permanent magnet motor such as a PMSM, comprising a stator having a 45 to 90 slot construction, a rotor assembly comprising from 50 to 80 magnetic poles, and that uses a winding pattern as follows: . . . /CA′/AB′/BB/B′C′/CA/A′A/AB/BC′/CC/C′A/A′B/B′B′/BC′/CA′/AA/A′B/B′C/C′C′/ . . . , where A′, B′, and C′ indicate a reverse in winding direction.

The permanent magnet motor such as the PMSM, can have a slot-pole combination of 48S56P, 60S50P, 60S70P, 72S60P, 84S70P; 45S50P, 54S60P, 63S56P, 63S70P, 72S64P, 72S80P, 81S72P, 90S80P; 54S66P, 72S56P, or 90S70P, where S is slots and P is magnetic poles.

Any permanent magnet shape can be used for the permanent magnets. For instance, the permanent magnet of the rotor assembly can be or include a plurality of flat top-shaped magnets. The permanent magnets can be bonded or otherwise attached or located to the inner periphery of a rotor ring (e.g., steel rotor ring). Or, the permanent magnets can similarly be used for an inner rotor design.

The permanent magnet motor such as the PMSM, can exhibit a minimum voltage per rpm constant (Ke) of 0.75 V/rpm, a maximum Ke of 4.0 V/rpm, or both. The permanent magnet motor (e.g., PMSM) can exhibit a Ke of from about 1.25 V/rpm to about 3.25 V/rpm, for example, from about 1.35 V/rpm to about 3.2 V/rpm. The motor can be run with an AC power source or DC power source. If an AC power source is used, the motor can be powered by a 1-phase or 3-phase power source. The motor can operate at a voltage of about 85V or higher, or at a voltage of about 600V or lower (e.g., operate at from about 85V to 600V). The same motor construction can be used in multiple different ceiling fans having different blade sizes. The permanent magnet motor can be brushless.

The stator can have a minimum outer diameter of 220 mm, and/or a minimum rotor outer diameter of 250 mm. The stator can have an outer diameter of from about 220 mm to about 340 mm, and the rotor can have an outer diameter of from about 250 mm to about 370 mm. The stator can have a minimum outer diameter of 340 mm and the rotor can have a minimum outer diameter of 370 mm. The motor can have a stack length of from about 10 mm to about 50 mm, for example, from about 15 mm to about 45 mm or from about 20 mm to about 40 mm. The motor has a minimum stack length of 20 mm More than one coil can be formed on each tooth, for example, two, three, four, or more coils can be formed on each tooth of the stator and can be connected together or separately energized.

As an option, the ceiling fan of the present invention is designed and capable of being operated at a speed of from 50 rpm to 180 rpm, and/or at a torque of from about 10 ft-lb to about 150 ft-lb, and/or at a wattage of from 400 W to 2200 W. The direct drive ceiling fan can exhibit a rated torque per volume (Kᵥ) of from 4.0×10⁶ ft-lb/m³ to 8.0×10⁶ ft-lb/m³, for example, from about 4.0×10⁶ ft-lb/m³ to about 6.0×10⁶ ft-lb/m³, or from 5.0×10⁶ ft-lb/m³ to about 7.0×10⁶ ft-lb/m³. The ceiling fan, when operating, generates very little, or zero, radial forces in either an x direction (Fx) or in a y direction (Fy) or both Fx and Fy. The ceiling operates at very low noise levels, vibration levels, or both.

The ceiling fan can comprise a direct drive construction or a gear-free construction. The construction enables the generation of high torque at low speed. The ceiling fan motor can have a compact structure, for example, including a rotor having an outer diameter of 370 mm and a stack height of 35 mm. The motor and ceiling fan can be made very light-weight, for example, to have a total ceiling fan weight of about 50 kg or less, such as 35 kg to 40 kg.

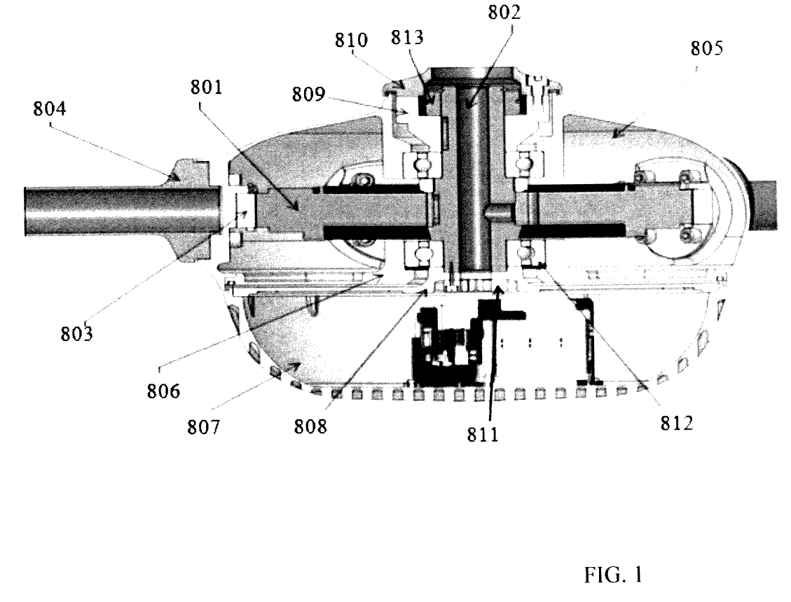

With reference to the figures, FIG. 1 is an example that shows a ceiling fan having a winding stator 801 mounted on a shaft 802 and that can be energized to rotate a rotor 803. The ceiling fan can be supported at the top thereof, for example, by a support shaft (not shown) connected to shaft 802. Shaft 802 can be connected to a support shaft via a first connector part 809, a second connector part 810, and one or more lock nuts 813. Fan blades (not shown) can be connected and moved by the rotor 803 via a fan blade coupling 804. A fan hub 805 can have two, three, four, five, six, or more fan blades connected thereto, each with a respective fan blade coupling 804. A bottom flange 806 can be connected to the bottom of fan hub 805. At the bottom of the ceiling fan, a controller cover 807 is provided. Cover 807 can further act as a heat sink for the motor controller and/or to provide cooling for control electronics. The cover can be made of aluminum or other metals or materials. A controller cover plate 808 can be provided to protect control electronics. A pressing cap 811 can be provided to allow wire access from winding stator 801 to a control unit mounted inside controller cooling cover 807. Rotor 803 and fan hub 805 rotate about stationary shaft 802 via bearings 812.

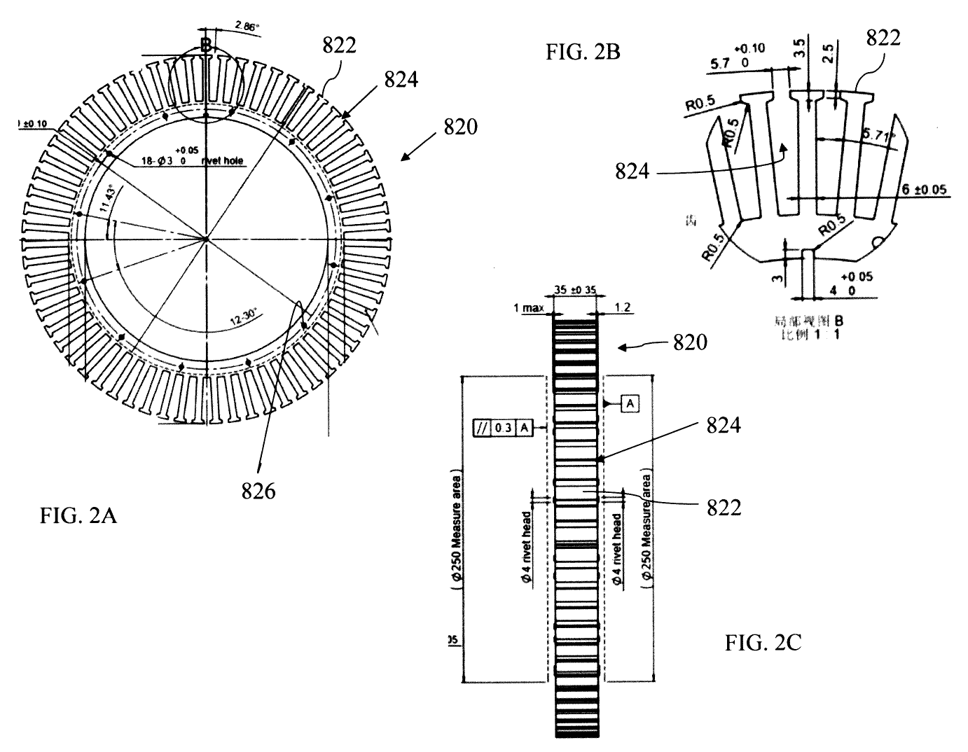

FIGS. 2A-2C show details of a winding stator that can be used but without coils wound around each tooth of the stator body. As shown in FIG. 2A, stator body 820 includes a plurality of teeth 822 with adjacent teeth being separated by slots 824. Rivet holes 826 can be present, and if so, can be pre-formed, drilled, punched, or otherwise formed into stator body 820 for mounting stator body 820 to other components and vice versa. Any conventional attachment mechanism/design can be used for mounting. FIG. 2B is an enlarged view of section B taken from FIG. 2A and shows teeth 822 and slots 824 in closer detail. FIG. 2C is a side-view of stator body 820. Other stator body designs, and numbers of teeth and slots, can be used.

For a given stator diameter, as the number of slots is increased the width of each slot is narrowed, which in-turn reduces slot area. To enlarge slot area, a deeper (or longer) slot can be used. For example, the stator body can be designed with a slot depth of from about 30 mm to about 50 mm or more, from about 35 mm to about 45 mm, or about 40 mm, for example, 40 mm. Each tooth can have any appropriate width, for example, a width of from about 5 mm to about 7.5 mm, from about 5.5 mm to about 6.5 mm, or from about 6 mm to about 7 mm. An insulation system can be used to cover the winding stator. As just one example, a novel 3-piece design can be used to cover top of the winding stator, the bottom of the winding stator, and the outside edges or circumference of the wound teeth.

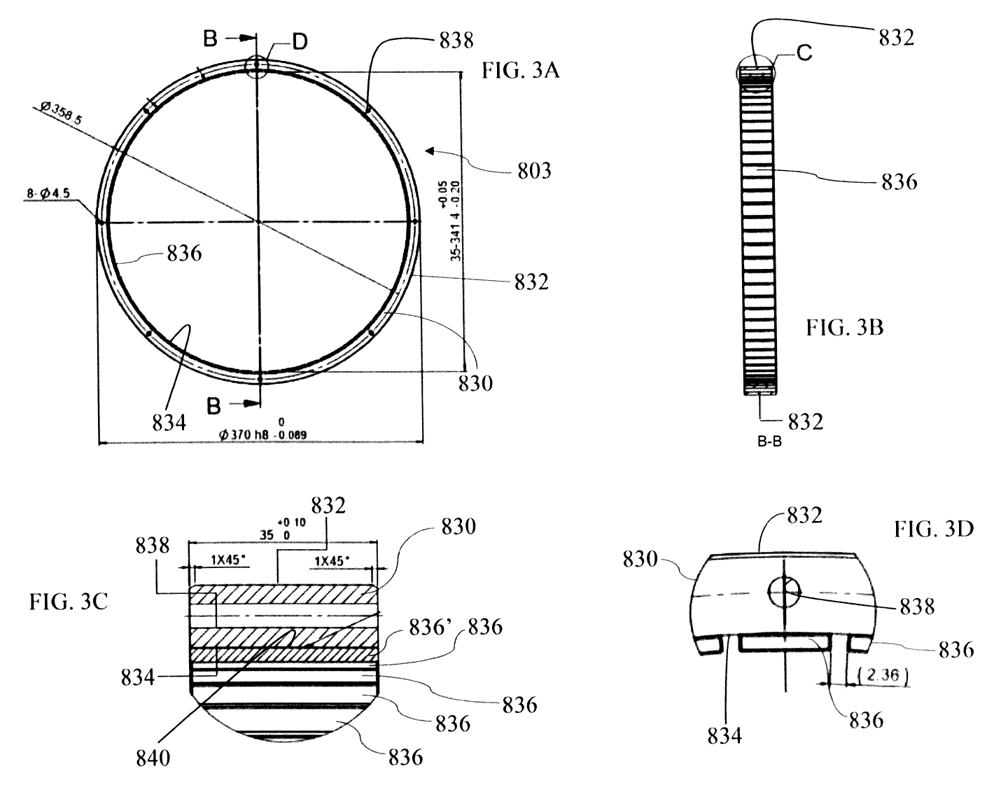

FIGS. 3A-3D show details of a rotor 803. As can be seen from FIG. 3A, rotor 803 comprises a steel ring 830 having an outer surface 832 and an inner surface 834. In this particular example, seventy (70) magnets 836 are evenly distributed around, and attached to the inner surface 834 of steel ring 830 to form a seventy-pole (70-pole) rotor. Rivet holes 838 are pre-formed, drilled, punched, or otherwise formed in steel ring 830 evenly spaced around steel ring 830. Again, any conventional attachment mechanism/design can be used for mounting. FIG. 3B is a cross-sectional view taken along line B-B in FIG. 3A and further depicts magnets 836 and outer surface 832 of the steel ring. FIG. 3C is an enlarged view of section C taken from FIG. 3B and shows a close-up view of rivet hole 838, outer surface 832, and a plurality of magnets 836. The cross-sectional view is taken through magnet 836′ and thus magnet 836′ is shown in cross-section. As an option to forming the rotor, a layer of adhesive 840 can be applied to inner surface 834 of steel ring 830 to attach magnets 836 (including magnet 836′) to inner surface 834. FIG. 3D is an enlarged view of section D taken from FIG. 3A and shows that magnets 836 are flat magnets bonded to the curved contour of inner surface 834.

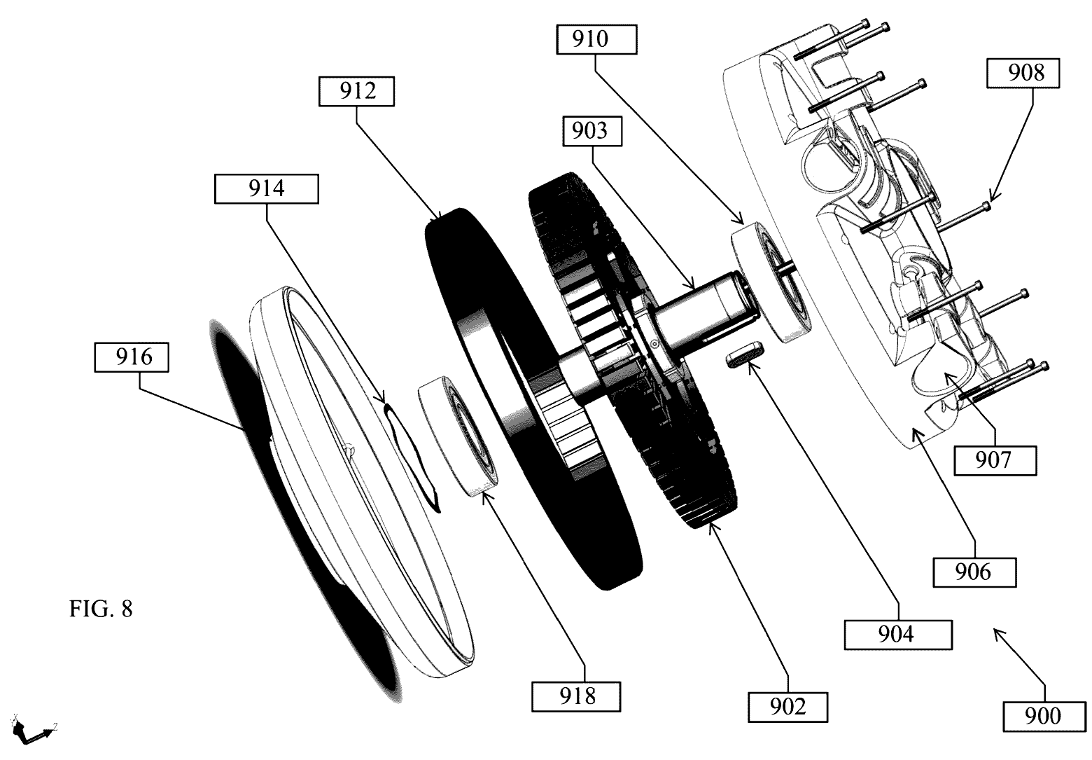

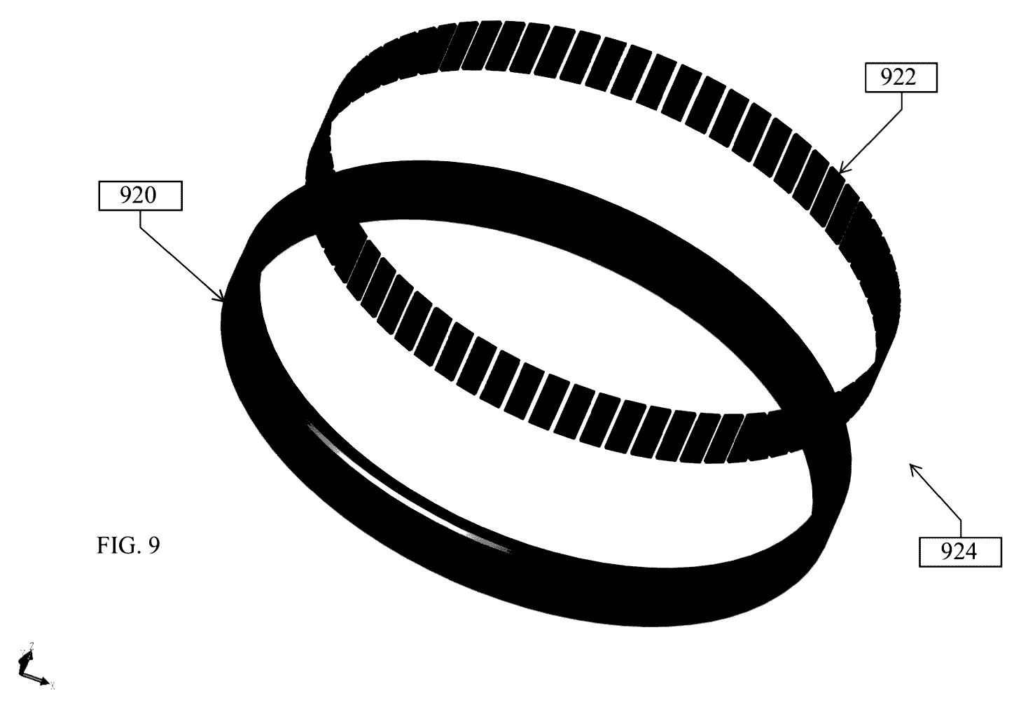

FIG. 8 is a further example that shows the permanent magnet motor components that are used with the ceiling fan of the present invention. The permanent magnet motor arrangement 900 in FIG. 8 shows a shaft 903. This shaft 903 can be connected to a support shaft. Fan blades (not shown) can be connected and moved by the rotor 912. Fan blades (not shown) can be connected to the top hub of 906 with a variety of connection mechanisms. FIG. 8 shows the top hub or cover 906 which can be connected to the bottom hub 916 using one or more attachment devices such as screws 908. The top hub 906 can include blade holders or openings 907 to receive fan blades. For purposes of the present invention, the blade holders are located, in any design of the present application, on the top hub or bottom hub. The bottom hub 916 can be any material such as aluminum or other metals and can further serve as a heat sink for the motor controller (not shown). A top bearing 910 and a bottom bearing 918 are located outside of the rotor 912 and stator 902. A key 904 can be used to maintain each of the components locked into the shaft 903. A spring wave or other type of gasket 914 can be used beneath the bottom bearing 918.

FIG. 9 provides a further example of the permanent magnet assembly 924 in this case 70 poles which can be attached to a metal ring 920 such as a steel ring to form the 70 pole rotor. The magnets that form the 70 pole can be attached to the ring 920 in any fashion as described herein.

As an option, in the present invention, the magnets can have any shape. With the present invention, however, even flat shaped magnets can be used. Flat magnet segments are easy to produce and are typically about 15% to 20% less expensive than arc magnet segments. There are 70 magnet segments exemplified in FIGS. 3A-3D, which are attached (e.g., glued) onto the steel ring of the rotor. The combination of the number of poles, for example, 70 poles, and steel rotor inner dimension, for example, 358.5 mm, can be purposely configured to allow flat magnet segments to be used and thus to lower cost while still achieving very low motor cogging torque. Such features, including the low level of cogging torque, can further reduce motor noise.

A spacing of from about 2.2 mm to about 2.6 mm between the magnet segments, for example, 2.36 mm, can be used so that high viscosity glue can be used instead of a plastic over mold. However, any attachment means, such as glue, snap fit, a cover, screws, pins, and the like can be used to hold the magnets in place.

A symmetric winding pattern about the stator is used. A symmetric winding pattern for the coils on the stator is where the pattern that is used to distribute three phases (A, B, and C) that forms the 3-phase part of the permanent magnet motor (e.g., PMSM) is a repeating pattern for the locations of the A phase, B phase, and C phase about the circular stator. The pattern that is used for distribution of the A phase coils is the same pattern that is used for distribution of the B phase coils and is the same pattern that is used for distribution of the C phase coils. This is different from an asymmetric winding pattern where no repeating pattern can be established for distributing the A phase coils, B phase coils, and C phase coils about the stator. For a symmetric winding pattern, there is also an equal number of A phase, B phase, and C phase coils on the stator.

The stator can be used in a permanent magnetic motor (e.g., PMSM) having from about 45 to about 90 slots and from about 50 to about 80 magnetic poles. The value of q in the equation below can be less than 1, such as less than 0.5, for example, 2/5, 2/7, 3/7, 3/8, 3/10, or 3/11. For different values of q, different winding patterns can be used. Appropriate electronic circuitry can be used to energize the different phases and combinations of phases and to alternate energization thereof. The motor can be run with an AC source or DC source. The system can be provided with a sensor motor controller or a sensor-less motor controller. As an example, the ceiling fan can be operated at a speed of up to 180 rpm or more and can have a minimum operating torque of 10 ft-lb.

The values of q calculated for exemplary slot and pole and symmetric winding combinations are shown in TABLE 1 below. The winding patterns shown in TABLE 1 indicate the direction of winding of the two coils on either side of each slot with each slot being separated by a backlash (/) which represents a tooth on the stator. The prime (′) symbol for A′, B′, and C′ indicates that the corresponding winding direction results in the wire or conductor coming out of the slot (wire is being wound such that otherwise is going away or out of the slot as viewed from observing slot from above) whereas the letters A, B, and C with no prime (') symbol indicate that the wire or conductor goes into the slot (wire is being wound such that the wire is going toward or in the slot as viewed from observing the slot from above).

The first slot (slot 1) in each winding pattern provided corresponds to the slot between the last coil of the stator and the first coil of the stator. For symmetric winding pattern q1, the first slot is taken up by a C phase coil toward the left-hand side thereof and an A phase coil toward the right-hand side thereof. The C phase coil is denoted “C′” indicating that the last coil is a C phase coil and is wound in a counter-clockwise direction around its respective tooth, i.e., the last tooth of the stator. As such, the C phase wire comes out of the first slot with winding the last C phase coil. The “A” designated for the first slot indicates that the first coil of the stator is an A phase coil that is wound in a counter-clockwise direction, but, being on the right-side of the first slot, means that the A phase wire goes in the first slot and out the second slot. From there, the A phase wire goes around the first tooth and comes out of the second slot. The second slot, according to the q1 symmetric winding pattern, thus includes the A phase wire coming out of the second slot (making it A′) on the left-hand side of the slot, due to counter-clockwise winding of the A phase wire around the first tooth of the stator. The second coil, formed around the second tooth of the stator, is wound in a clockwise direction such that the A phase wire also comes out of the second slot on the right-hand side of the second slot. Accordingly, the second slot has two A phase conductors coming out of the slot and is thus designated “/A′A′/”.

TABLE 1
Slot Pole Combination Versus Symmetric Winding Pattern Selection with q* < 1

| Number | No. Poles | | | | | | | |
|---|---|---|---|---|---|---|---|---|
| of Slots | 50 | 56 | 60 | 64 | 66 | 70 | 72 | 80 |
| 45 | q2 = 3/10 | | | | | | | |
| 48 | | q1 = 2/7 | | | | | | |
| 54 | | | q2 = 3/10 | | q3 = 3/11 | | | |
| 60 | q1 = 2/5 | | | | | q1 = 2/7 | | |
| 63 | | q2 = 3/8 | | | | q2-3/10 | | |
| 72 | | q3 = 3/7 | q1 = 2/5 | q2 = 3/8 | | | | q2 = 3/10 |
| 81 | | | | | | | q2 = 3/8 | |
| 84 | | | | | | q1 = 2/5 | | |
| 90 | | | | | | q3 = 3/7 | | q2 = 3/8 |

| Winding Patterns Versus q | |
|---|---|
| q1 | . . ./C′A/A′A′/AB′/BB/B′C/C′C′/CA′/AA/A′B/B′B′/BC′/CC/. . . |
| q2 | . . ./C′A/A′A′/AA/A′B/B′B′/BB/B′C/C′C′/CC/. . . |
| q3 | . . ./CA′/AB′/BB/B′C′/CA/A′A/AB′/BC′/CC/C′A/A′B/B′B′/BC′/CA′/AA/A′B/ |
| | B′C/C′C′/. . . |

q* = Slot/Pole/Phase (3)
A′ = Return conductor responding to conductor A. The prime (′) symbol indicates a winding direction that results in the conductor coming out of the slot.

The present invention will be further clarified by the following examples, which are intended to be exemplary of the present invention.

### EXAMPLES

### Example 1

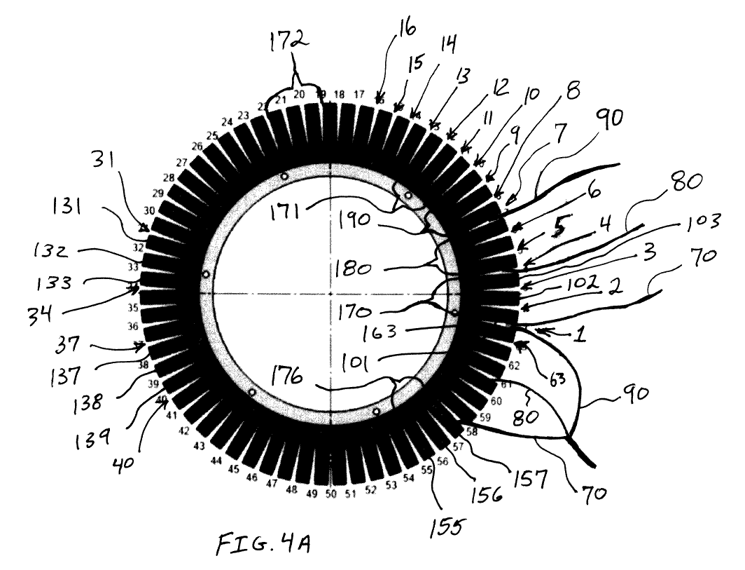

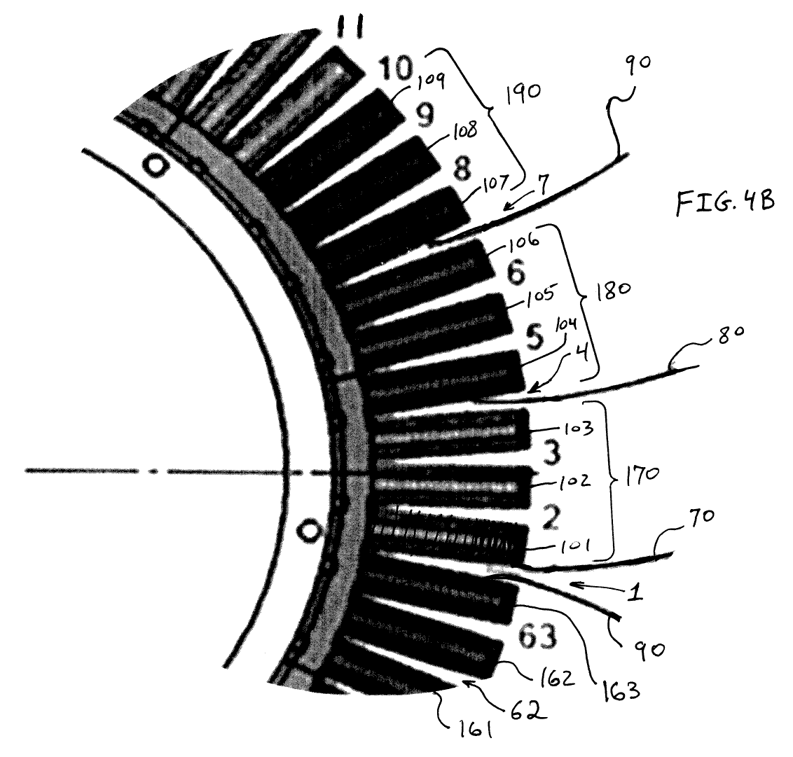

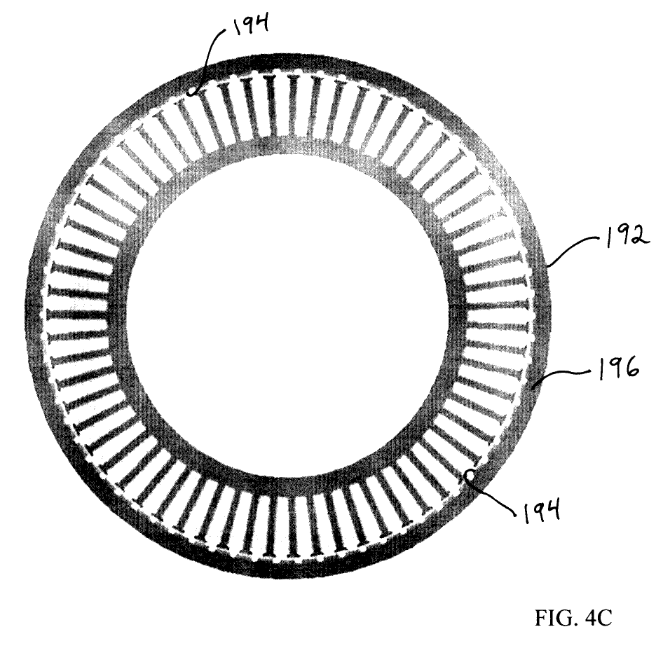

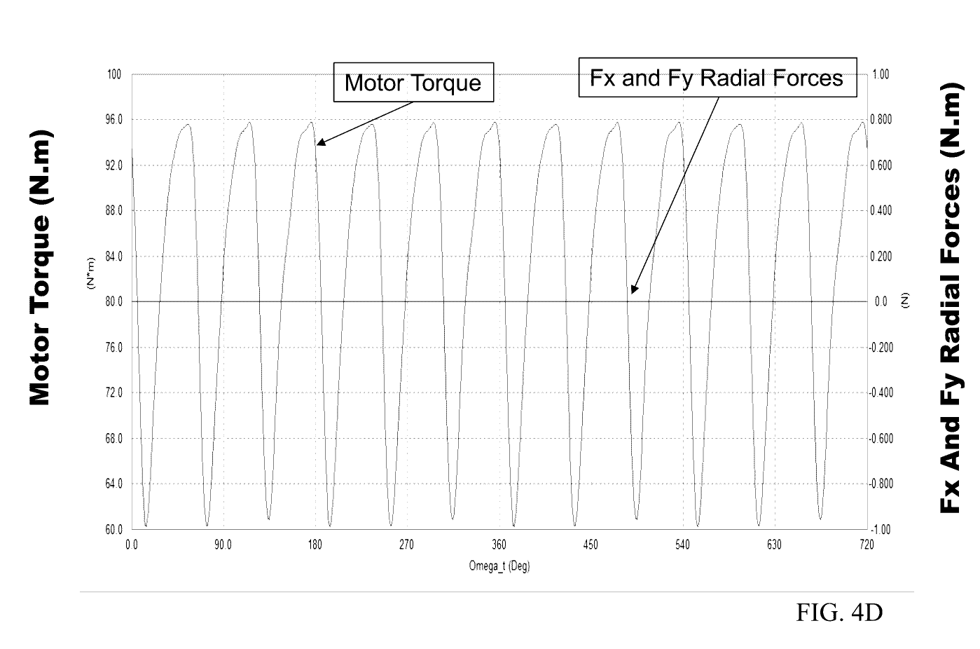

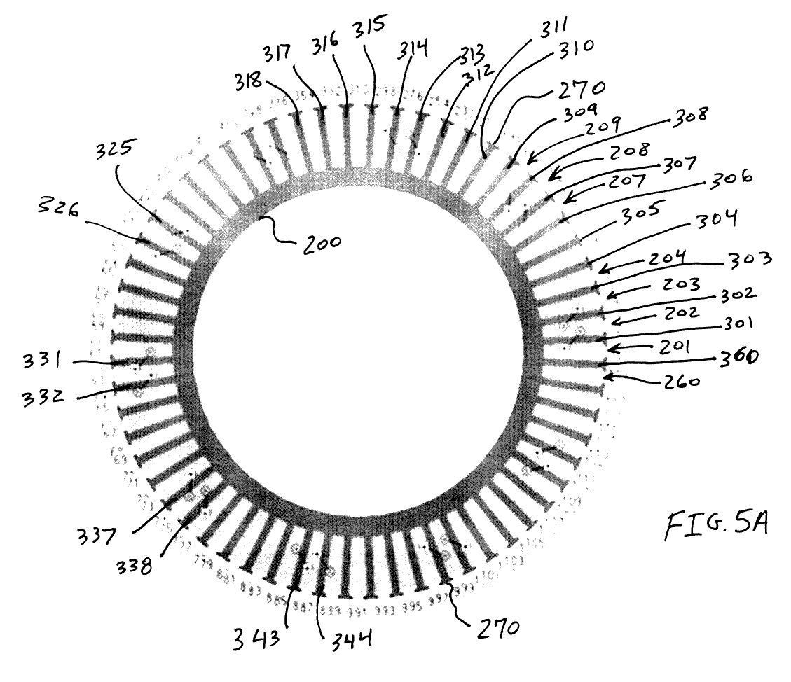

FIG. 4A shows a stator and a stator winding pattern of a symmetric winding configuration according to a first example. The stator was used in a PMSM having a 63 slot construction and from 70 magnetic poles. As can be seen, the value of q in the equation:

$$q = ( \frac{\# of slots}{\# of magnetic poles} ) \div ( number of Phases )$$

is less than 1, more specifically, 63÷70÷3=^{3/10}. The wire used to form the coils around each tooth of the stator was a 0.9 mm diameter copper wire having a G2 enameled insulation and a temperature index of 180° C. Each coil of the stator comprised 110 turns of the wire. The winding direction used for each of the 63 coils of the stator is shown in TABLE 2 below and is explained in more detail below. The 63 coils numbered in TABLE 2 below and shown in FIG. 4A begin with coil 101 and are respectively consecutively numbered to the 63^{rd} coil, coil 163.

TABLE 2

| U Phase | | | V Phase | | | W Phase | | |
|---|---|---|---|---|---|---|---|---|
| | Slot No. | | | Slot No. | | | Slot No. | |
| Coil | Go | Out | Coil | Go | Out | Coil | Go | Out |
| 101 | 1 | 2 | 104 | 4 | 5 | 107 | 7 | 8 |
| 102 | 3 | 2 | 105 | 6 | 5 | 108 | 9 | 8 |
| 103 | 3 | 4 | 106 | 6 | 7 | 109 | 9 | 10 |
| 110 | 10 | 11 | 113 | 13 | 14 | 116 | 16 | 17 |
| 111 | 12 | 11 | 114 | 15 | 14 | 117 | 18 | 17 |
| 112 | 12 | 13 | 115 | 15 | 16 | 118 | 18 | 19 |
| 119 | 19 | 20 | 122 | 22 | 23 | 125 | 25 | 26 |
| 120 | 21 | 20 | 123 | 24 | 23 | 126 | 27 | 26 |
| 121 | 21 | 22 | 124 | 24 | 25 | 127 | 27 | 28 |
| 128 | 28 | 29 | 131 | 31 | 32 | 134 | 34 | 35 |
| 129 | 30 | 29 | 132 | 33 | 32 | 135 | 36 | 35 |
| 130 | 30 | 31 | 133 | 33 | 34 | 136 | 36 | 37 |
| 137 | 37 | 38 | 140 | 40 | 41 | 143 | 43 | 44 |
| 138 | 39 | 38 | 141 | 42 | 41 | 144 | 45 | 44 |
| 139 | 39 | 40 | 142 | 42 | 43 | 145 | 45 | 46 |
| 146 | 46 | 47 | 149 | 49 | 50 | 152 | 52 | 53 |
| 147 | 48 | 47 | 150 | 51 | 50 | 153 | 54 | 53 |
| 148 | 48 | 49 | 151 | 51 | 52 | 154 | 54 | 55 |
| 155 | 55 | 56 | 158 | 58 | 59 | 161 | 61 | 62 |
| 156 | 57 | 56 | 159 | 60 | 59 | 162 | 63 | 62 |
| 157 | 57 | 58 | 160 | 60 | 61 | 163 | 63 | 1 |

For each of the 3-phases of the PMSM, seven sets of 3 coils each were wound. The sets were evenly (symmetrically) spaced around the stator. The 63 slots separated the 63 coils, and each coil was formed between two adjacent slots. The arrangement of coils was in a symmetric pattern. The stator shown in FIG. 4A had three coils 101, 102, 103 of a first phase (the U phase), connected together in series by a U phase wire 70. U phase coils 101, 102, 103 made-up a first set of U phase coils 170. There were seven such sets of three U phase coils in the stator, including, for example, a second set 171 and a third set 172. A last set of three U phase coils 176 terminated with U phase wire 70 being Y-connected with ends of a V phase wire 80 and a W phase wire 90. First set of U phase coils 170 was followed by three coils (coils 104, 105, 106) of a second phase (the V phase), which, in-turn, were followed by three coils (coils 107, 108, 109) of a third phase (the W phase). The pattern of three U phase coils, followed by three V phase coils, followed by three W phase coils was then repeated six times around the entire stator. For purposes of this invention, the U phase is also considered the A phase, the V phase is also considered the B phase, and the W phase is also considered the C phase.

To form each coil, one of the copper wires was wound around a respective tooth of the stator. The direction used for winding of the copper wire around the respective tooth, for each coil, can be discerned from TABLE 2. Starting from a plane above the page, coil 101, which is positioned between slot 1 and slot 2, was formed by wrapping U phase wire 70 down into slot 1, around the bottom of the first tooth, and out through slot 2, and around the top of the first tooth, with such steps being collectively referred to as one turn. U phase wire 70 was then directed back down into slot 1 and the wrapping continued in the counter-clockwise direction, for a total of 110 turns. TABLE 2 abbreviates a winding direction going into slot 1 as “Go 1” (also referred to herein as “Current In 1”). Wire 70 then comes out of the second slot, slot 2, which direction is abbreviated in TABLE 2 as “Out 2” (also referred to herein as “Current Out 2”). U phase wire 70 was used in this example to form the U phase coils and hence is also referred to as the U phase wire or U phase conductor.

After 110 turns around the tooth, and on the last time out of slot 2, U phase wire 70 was then directed around the second tooth, which was positioned between slot 2 and slot 3, to begin the formation of a second coil 102. For wrapping around the second tooth, however, the direction of winding was clockwise. U phase wire 70 was wrapped around the second tooth 110 turns, i.e., times completely around, to form coil 102. After the last time around the second tooth, to complete the formation of coil 102, U phase wire 70 was then directed down into the third slot, slot 3, around the bottom of the third tooth, up through and out of slot 4, and around the top of the third tooth, thus beginning the formation of coil 103. Coil 103 was formed by counter-clockwise wrapping of U phase wire 70 around the third tooth. Like with the other coils, coil 103 was formed by turning the copper wire around the respective tooth, here, the third tooth, for 110 turns.

After coil 103 was formed, U phase wire 70 then skipped six teeth and formed the next (fourth) U phase coil by leading directly to and around the tenth tooth. U phase wire 70 was directed into slot 10 (Go 10), around the bottom of the tenth tooth, up and out of slot 11 (Out 11), around the top of the tenth tooth, and back down into slot 10. As such, wire 70 was wrapped around the tenth tooth in a counter-clockwise direction. The counter-clockwise, clockwise, counter-clockwise pattern continued for winding every third set of three coils until the winding of all 21 U phase coils was completed.

After completion of the U phase coils, the V phase coils and the W phase coils were then formed. It is to be understood, however, that before, during, or after completion of all the U phase coils, the V phase coils, the W phase coils, or both, can independently be formed. The first set of three V phase coils was formed around the fourth, fifth, and sixth teeth of the stator. With further reference to TABLE 2, the first V phase coil was labeled coil 104 and was formed on the fourth tooth of the stator by leading V phase wire 80 into slot 4, around the bottom of the fourth tooth, up and out of slot 5 and back around the top of the fourth tooth. This counter-clockwise winding was repeated until V phase wire 80 was wound around the fourth tooth for 110 turns. Upon completion of the 110 turns, V phase wire 80 was directed out of slot 5, up and around the top of the fifth tooth, down into slot 6, and around the bottom of the fifth tooth, for winding in the reverse, i.e., clockwise, direction for 110 turns. The third V phase coil was labeled as coil 106 and was formed around the sixth tooth of the stator by similarly wrapping but in a counter-clockwise direction. V phase wire 80 was directed down into slot 6, around the bottom of the sixth tooth, up and out of slot 7, and around the top of the sixth tooth so it could be pulled back down into slot 6, and the wrapping was repeated until the wire had made 110 turns. Upon completion of wrapping the third V phase coil, i.e., coil 106, the V phase wire 80 then skipped the next six teeth of the stator and was positioned such that it could be used to similarly wrap every third set of three teeth, thereafter. The first set of V phase coils is labeled 180 in FIG. 4A. For each set of three V phase coils, the coils were wrapped in a counter-clockwise, clockwise, counter-clockwise pattern, respectively, just as was done with U phase wire 70 to form the sets of U phase coils.

Forming the first set of three W phase coils started by wrapping W phase wire 90 around the seventh tooth of the stator and then wrapping the eighth tooth, and then the ninth tooth, to form coils 107, 108, 109. These three coils are collectively referred to as a first set of W phase coils 190. As with first set of U phase coils 170 and first set of V phase coils 180, each set of three W phase coils was wrapped according to the same winding pattern, specifically, the first coil of each set of three W phase coils was wrapped in a counter-clockwise direction, the second coil of each set of three W phase coils was wrapped in a clockwise direction, and the third coil of each set of three W phase coils was wrapped in a counter-clockwise direction. As can be seen from FIG. 4A, the resulting winding patterns for each of U phase wire 70, V phase wire 80, and W phase wire 90 form seven sets of three coils each. The sets are evenly spaced apart from one another and follow a pattern of three U phase coils, followed by three V phase coils, followed by three W phase coils. The repeating pattern thus had nine coils and repeated itself six times for a total of seven patterns of nine coils.

FIG. 4B is an enlarged view of a circular section of FIG. 4A showing first set of U phase coils 170, first set of V phase coils 180, and first set of W phase coils 190. As can be seen, first set of U phase coils 170 comprised coils 101, 102, and 103 and was formed from U phase wire 70. First set of V phase coils 180 comprised coils 104, 105, and 106 and was formed from V phase wire 80. First set of W phase coils 190 comprised coils 107, 108, and 109 and was formed from W phase wire 90. The same W phase wire 90 was used to form every third set of three coils including the last set of W phase coils that comprised coils 161, 162, and 163.

FIG. 4C shows a PMSM having the stator shown in FIG. 4A surrounded by an outer rotor having seventy (70) poles made up of seventy (70) flat magnets 194 bonded to a steel rotor ring 196. Such a configuration of 63 slots and 70 poles produced virtually zero radial forces and thus, very minimal vibrations. As shown in the graph of FIG. 4D, the radial forces (Fx, Fy) generated by operation of the motor running at 50 rpm as an example shown in FIG. 4C were virtually non-existent, despite the varying torque values. Note, both Fx and Fy radial forces are shown by the same line in this figure since the forces were zero for Fx and Fy. The motor shown in FIG. 4C represents one of many examples of slot and pole combinations with specific symmetric winding patterns that result in a q value of less than 0.5 according to the equation for q denoted above. The value of q for such a configuration is shown in TABLE 1 above.

It can be seen that the configuration shown in FIGS. 4A-4C and denoted in TABLE 2 follows a q2 symmetric winding pattern wherein the U phase shown in TABLE 2 corresponds to the A phase shown in TABLE 1, the V phase correspondence to the B phase, and the W phase corresponds to the C phase.

Moreover, the motor produced an almost linear increase in Ke at start-up. FIG. 7 is a graph showing the voltage per rpm constant (Ke) as a function of the number of turns of the motor, for the motor described and shown in connection with FIGS. 4A-4C. There is a linear increase in the value of Ke relative to turns of the motor, through the range of Ke values of from about 1.25 to about 3.25.

### Example 2

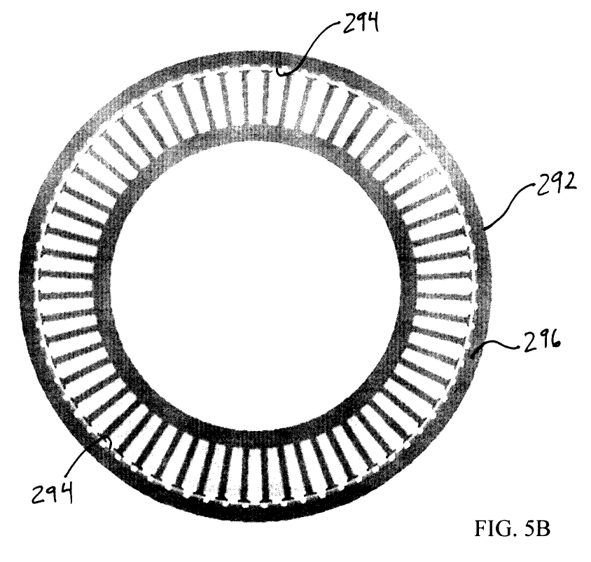

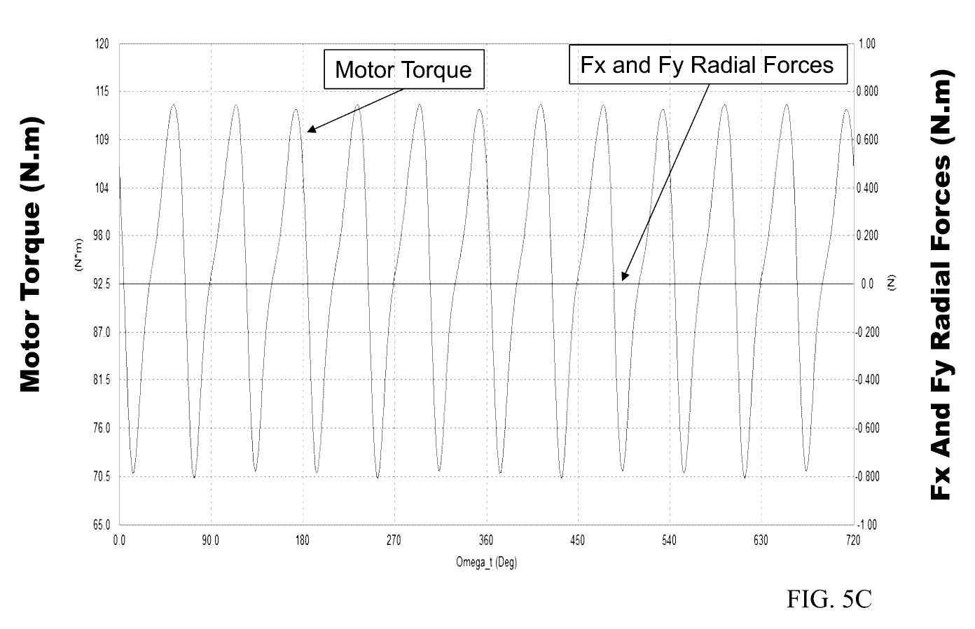

Following the approach and discussion of Example 1, FIG. 5A shows another example of a stator that can also be used with a 70-pole rotor to provide a PMSM. As shown in FIG. 5A, stator 200 comprised sixty (60) teeth 270 separated by sixty (60) slots 201-260, an exemplary number of which are labeled. Each tooth 270 was wound by either a U phase wire, a V phase wire, or a W phase wire according to the q1 winding pattern shown in TABLE 1. The rotor was a 70-pole rotor, specifically, rotor 292 shown in FIG. 5B, and the resulting motor was a PMSM that generated virtually zero radial forces during operation. The winding pattern for the stator shown in FIG. 5A comprised the symmetric winding pattern as shown in TABLE 3 below. For the sake of simplicity, TABLE 3 shows the winding pattern for just the first phase (the U phase) of the 3-phase motor. Of the 60 coils, the U phase coils included every third set of two coils, specifically, the set comprising coils 301 and 302, the set comprising coils 307 and 308, the set comprising coils 313 and 314, and so on. The V phase coils comprised every third set of two coils beginning with the set comprising coils 303 and 304, specifically, the set of coils comprising coils 303 and 304, the set of coils comprising coils 309 and 310, the set of coils comprising coils 315 and 316, and so on. The W phase coils comprised every third set of two coils beginning with coil 305, specifically, the set of coils comprising coils 305 and 306, the set of coils comprising coils 311 and 312, the set of coils comprising coils 317 and 318, and so on.

TABLE 3
Phase U

Slot Number

| Coil | Go | Out |
|---|---|---|
| 301 | 201 | 202 |
| 302 | 203 | 202 |
| 307 | 208 | 207 |
| 308 | 208 | 209 |
| 313 | 212 | 213 |
| 314 | 214 | 213 |
| 319 | 220 | 219 |
| 320 | 220 | 221 |
| 325 | 225 | 226 |
| 326 | 227 | 226 |
| 331 | 232 | 231 |
| 332 | 232 | 233 |
| 337 | 237 | 238 |
| 338 | 239 | 238 |
| 343 | 243 | 242 |
| 344 | 243 | 244 |

With reference again to TABLE 1, it can be seen that the symmetric winding pattern used to form the coils of the stator shown in FIGS. 5A and 5B corresponds to winding pattern q1, wherein the U phase shown and described with reference to FIGS. 5A and 5B corresponds to the A phase denoted in TABLE 1, the V phase corresponds to the B phase, and the W phase corresponds to the C phase.

The graph shown in FIG. 5C shows that, despite significant levels of torque, the motor illustrated in FIGS. 5A and 5B including the q1 winding pattern exemplified in TABLE 3 produced virtually zero radial forces (Fx, Fy), when operated at 50 rpm. Note, both Fx and Fy radial forces are shown by the same line in this figure since the forces were zero for Fx and Fy.

### Example 3

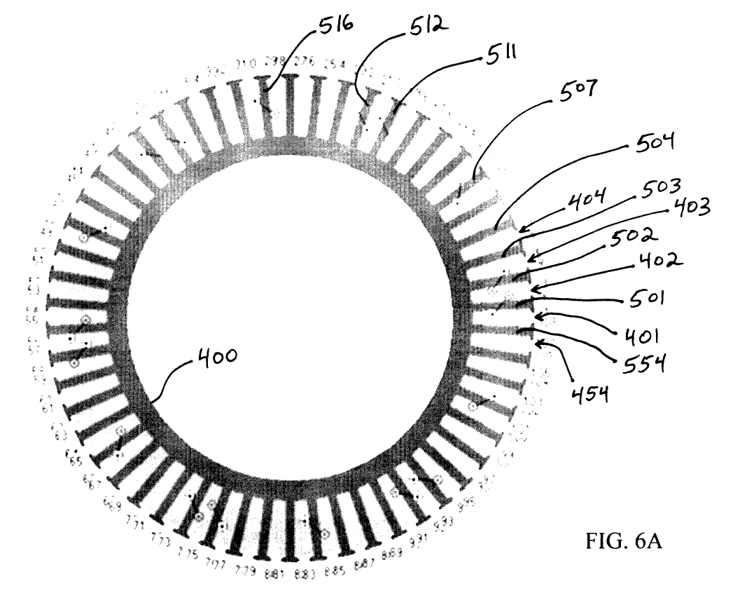

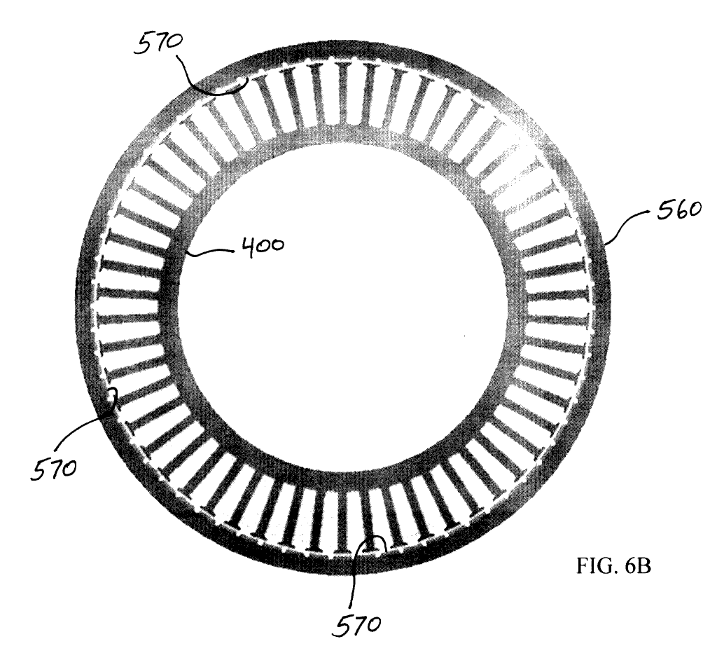

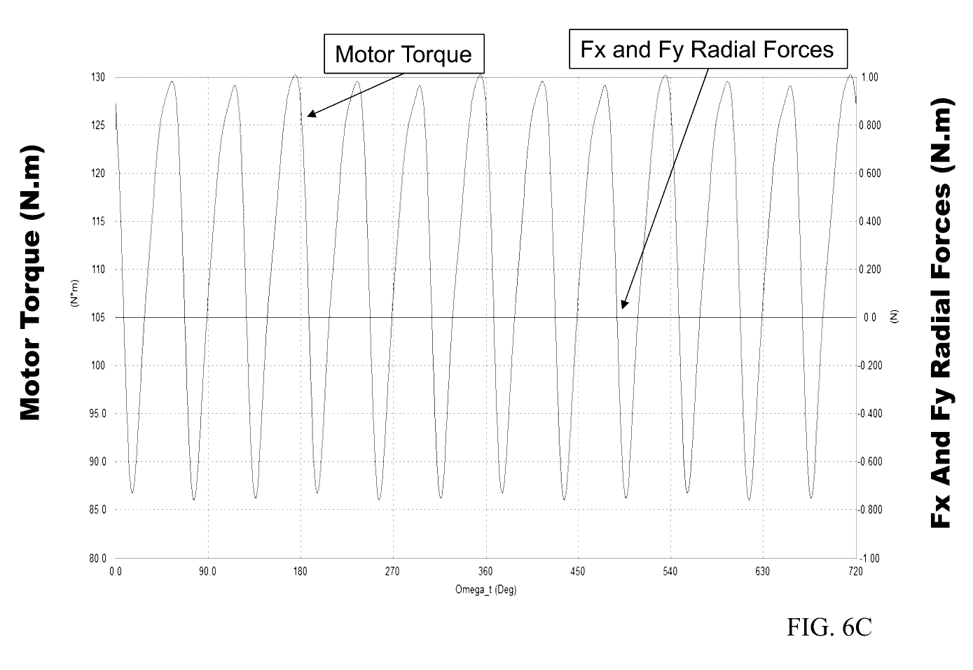

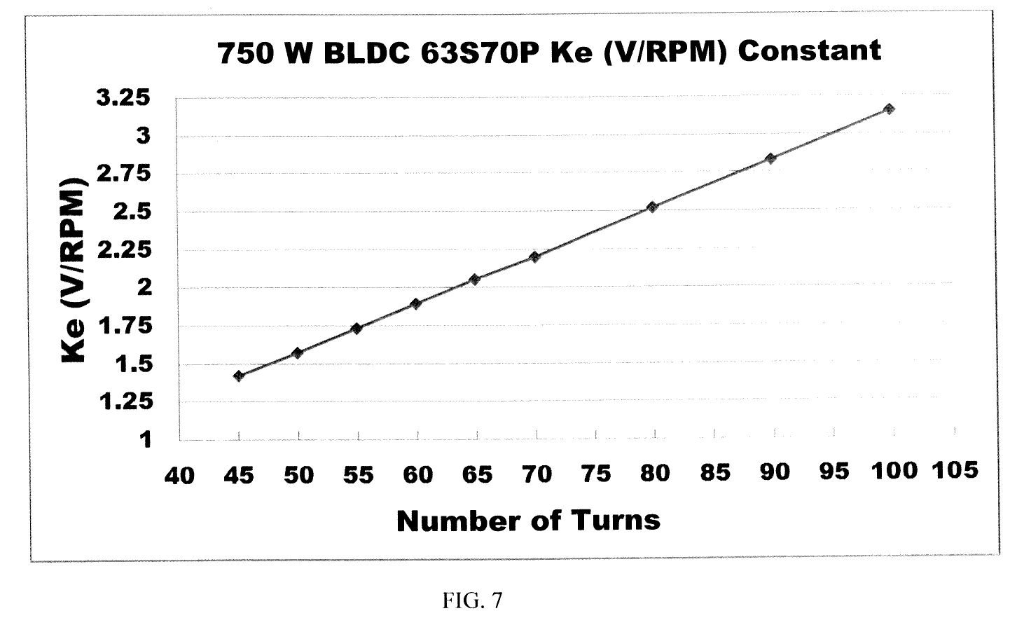

Following the approach and discussion of Example 1, FIG. 6A shows a stator comprising 54 teeth that were symmetrically wound and used with a 66-pole rotor to form a PMSM that exhibited virtually zero radial forces. Each of the three wires, one for each phase, was wound around a respective set of teeth. The winding pattern followed the q3 winding pattern shown in TABLE 1 above. The fifty-four (54) teeth of stator 400 were wound to form coils designated 501-554, respectively and consecutively, and an exemplary number of the coils are labeled in FIG. 6A. There were fifty-four (54) slots in stator 400 designated 401-454, respectively and consecutively, and an exemplary number of the slots are labeled in FIG. 6A. The winding pattern that was used for the U phase wire is shown in TABLE 4 below. The U phase, V phase, and W phase described herein correspond to the A phase, B phase, and C phase, respectively, denoted in the winding patterns shown in TABLE 1 above.

TABLE 4
Phase U

Slot Number

| Coil | Go | Out |
|---|---|---|
| 501 | 401 | 402 |
| 502 | 403 | 402 |
| 506 | 406 | 407 |
| 510 | 411 | 410 |
| 511 | 411 | 412 |
| 515 | 416 | 415 |
| 519 | 419 | 420 |
| 520 | 421 | 420 |
| 524 | 424 | 425 |
| 528 | 429 | 428 |
| 529 | 429 | 430 |
| 533 | 434 | 433 |
| 537 | 437 | 438 |
| 538 | 439 | 438 |
| 542 | 442 | 443 |
| 546 | 447 | 446 |
| 547 | 447 | 448 |
| 551 | 452 | 451 |

FIG. 6B shows stator 400 of FIG. 6A surrounded by a rotor 560 that comprised sixty-six (66) poles in the form of magnetic segments 570. The PMSM thus had 54 slots, 66 poles, and three phases. Accordingly, the q value of such a configuration is 54÷66÷3=3/11. The value of q is less than 0.5 and, as shown in TABLE 1, the winding pattern selected for symmetrically winding the coils was the q3 pattern shown.

Unlike symmetrical winding patterns q 1 and q2 that repeat themselves after twelve (12) slots and nine (9) slots, respectively, the q3 winding pattern repeats itself after every eighteen (18) slots. The q3 winding pattern also includes some single coils for each phase, which do not have same phase coils adjacent thereto.

The graph shown in FIG. 6C shows that, despite significant levels of torque, the motor illustrated in FIGS. 6A and 6B including the q3 winding pattern exemplified in TABLE 4 produced virtually zero radial forces (Fx, Fy), when operated at 50 rpm. Note, both Fx and Fy radial forces are shown by the same line in this figure since the forces were zero for Fx and Fy.

### Comparative Example

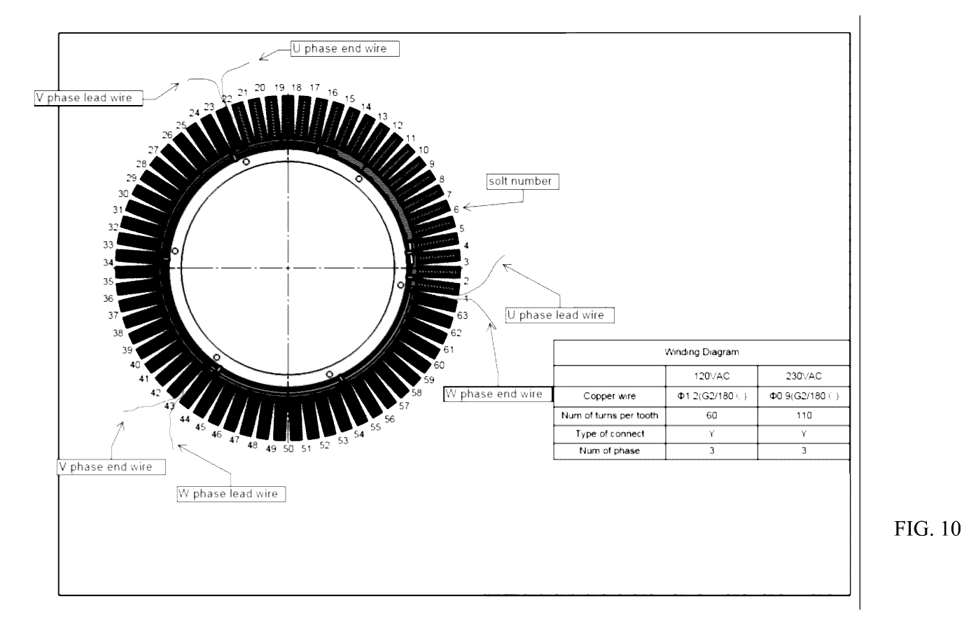

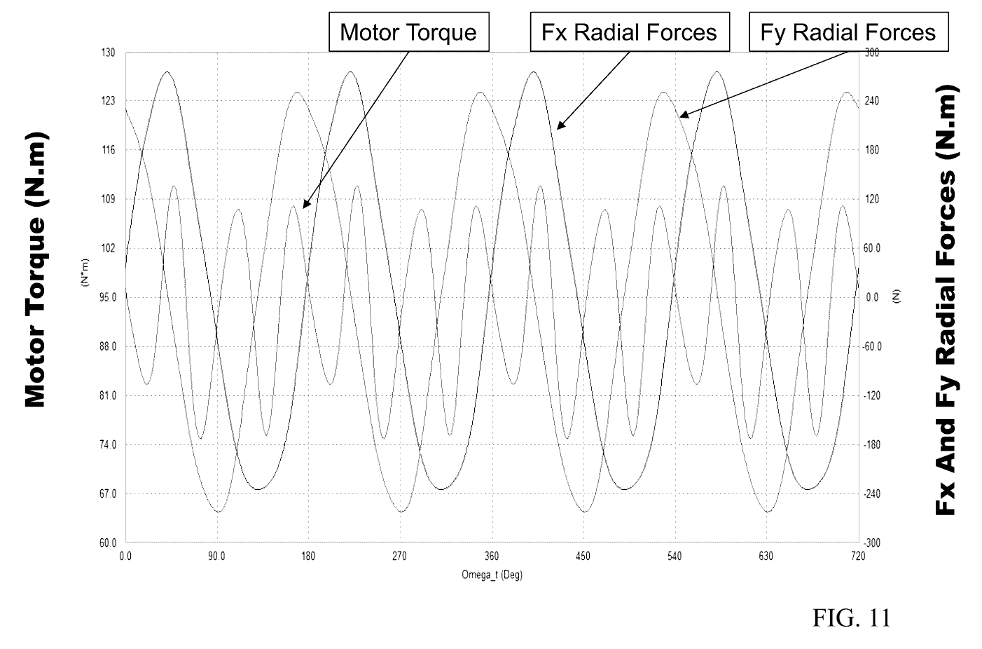

Following the discussion of Example 1, in this comparative example, a stator was constructed having 63 slots or 63 teeth that were asymmetrically wound and used with a 62-pole rotor to form a PMSM. The asymmetric winding pattern for this example is set forth in TABLE 5 below. FIG. 10 shows a top view of a winding stator used. A PMSM was used in a ceiling fan application, and the radial forces (Fx and Fy) were well above zero when operated at 50 rpm. This is shown in FIG. 11 which provides calculations of the radial forces (Fx, Fy) for this comparative example. As can be seen, the radial forces showed immense shifting causing violent vibrations of the motor.

Attorney Docket No. 3048-001

TABLE 5

| U Phase | | | V Phase | | | W Phase | | |
|---|---|---|---|---|---|---|---|---|
| | Slot No. | | | Slot No. | | | Slot No. | |
| Coil | Go | Out | Coil | Go | Out | Coil | Go | Out |
| 1 | 1 | 2 | 22 | 22 | 23 | 43 | 43 | 44 |
| 2 | 3 | 2 | 23 | 24 | 23 | 44 | 45 | 44 |
| 3 | 3 | 4 | 24 | 24 | 25 | 45 | 45 | 46 |
| 4 | 5 | 4 | 25 | 26 | 25 | 46 | 47 | 46 |
| 5 | 5 | 6 | 26 | 26 | 27 | 47 | 47 | 48 |
| 6 | 7 | 6 | 27 | 28 | 27 | 48 | 49 | 48 |
| 7 | 7 | 8 | 28 | 28 | 29 | 49 | 49 | 50 |
| 8 | 9 | 8 | 29 | 30 | 29 | 50 | 51 | 50 |
| 9 | 9 | 10 | 30 | 30 | 31 | 51 | 51 | 52 |
| 10 | 11 | 10 | 31 | 32 | 31 | 52 | 53 | 52 |
| 11 | 11 | 12 | 32 | 32 | 33 | 53 | 53 | 54 |
| 12 | 13 | 12 | 33 | 34 | 33 | 54 | 55 | 54 |
| 13 | 13 | 14 | 34 | 34 | 35 | 55 | 55 | 56 |
| 14 | 15 | 14 | 35 | 36 | 35 | 56 | 57 | 56 |
| 15 | 15 | 16 | 36 | 36 | 37 | 57 | 57 | 58 |
| 16 | 17 | 16 | 37 | 38 | 37 | 58 | 59 | 58 |
| 17 | 17 | 18 | 38 | 38 | 39 | 59 | 59 | 60 |
| 18 | 19 | 18 | 39 | 40 | 39 | 60 | 61 | 60 |
| 19 | 19 | 20 | 40 | 40 | 41 | 61 | 61 | 62 |
| 20 | 21 | 20 | 41 | 42 | 41 | 62 | 63 | 62 |
| 21 | 21 | 22 | 42 | 42 | 43 | 63 | 63 | 1 |

The present invention includes the following aspects/embodiments/features in any order and/or in any combination:
1. A direct drive ceiling fan comprising:
at least one blade, and a permanent magnet motor as a driving source for the ceiling fan,
wherein the permanent magnet motor is mounted on a shaft and comprises a stator having an axis, a 45 to 90 slot construction, and multiple stator winding coils having a symmetrical winding pattern on said stator; and
a rotor assembly rotatably mounted on the shaft and comprising a circular casing with a periphery, and having a permanent magnet present on the periphery and interacting with the stator winding coils of the stator; wherein said permanent magnet has from 50 to 80 magnetic poles,
and wherein a motor controller is used to energize the stator winding coils, the motor controller changes current of the stator windings to produce magnetic fields required to drive the rotor assembly and the at least one blade.
2. The direct drive ceiling fan of any preceding or following embodiment/feature/aspect, wherein each coil of the multiple stator winding coils has from 30 turns to 150 turns per coil.
3. The direct drive ceiling fan of any preceding or following embodiment/feature/aspect, wherein the direct drive ceiling fan has an air flow range of from about 50,000 CFM to about 350,000 CFM.
4. The direct drive ceiling fan of any preceding or following embodiment/feature/aspect, wherein q is less than 0.5, where

$$q = ( \frac{\# of slots}{\# of magnetic poles} ) \div ( number of Phases )$$

5. The direct drive ceiling fan of any preceding or following embodiment/feature/aspect, wherein the permanent magnet motor, when on, operates with zero radial forces (Fx, Fy).
6. The direct drive ceiling fan of any preceding or following embodiment/feature/aspect, wherein said winding pattern is . . . /C′A/A′A′/AB′/BB/B′C/C′C′/CA′/AA/A′B/B′B′/BC′/CC/ . . . , where A′, A′, and C′ indicate a reverse in winding direction.
7. The direct drive ceiling fan of any preceding or following embodiment/feature/aspect, wherein said winding pattern is . . . /C′A/A′A′/AA/A′B/B′B′/BB/B′C/C′C′/CC/ . . . , where A′, B′, and C′ indicate a reverse in winding direction.
8. The direct drive ceiling fan of any preceding or following embodiment/feature/aspect, wherein said winding pattern is . . . /CA′/AB′/BB/B′C′/CA/A′A/AB′/BC′/CC/C′A/A′B/B′B′/BC∵/CA′/AA/A′B/B′C/C′C′/ . . . , where A′, B′, and C′ indicate a reverse in winding direction.
9. The direct drive ceiling fan of any preceding or following embodiment/feature/aspect, wherein said permanent magnet motor has a slot-pole combination of 48S56P, 60S50P, 60S70P, 72S60P, 84S70P; 45S50P, 54S60P, 63S56P, 63S70P, 72S64P, 72S80P, 81S72P, 90S80P; 54S66P, 72S56P, or 90S70P, where S is slots and P is poles.
10. The direct drive ceiling fan of any preceding or following embodiment/feature/aspect, wherein said permanent magnet is a plurality of flat magnets.
11. The direct drive ceiling fan of any preceding or following embodiment/feature/aspect, wherein said permanent magnet motor has a minimum Ke of 0.75 V/rpm.
12. The direct drive ceiling fan of any preceding or following embodiment/feature/aspect, wherein said permanent magnet motor has a maximum Ke of 3.5 V/rpm.
13. The direct drive ceiling fan of any preceding or following embodiment/feature/aspect, wherein said stator has a minimum outer diameter of 220 mm, and/or a minimum rotor outer diameter of 250 mm.
14. The direct drive ceiling fan of any preceding or following embodiment/feature/aspect, wherein said permanent magnet motor has a stack length of from about 10 mm to about 50 mm.
15. The direct drive ceiling fan of any preceding or following embodiment/feature/aspect, wherein said ceiling fan operates an rpm of from 50 rpm to 180 rpm, a torque of from about 10 ft-lb to about 150 ft-lb, and/or 400 W to 2200 W.
16. The direct drive ceiling fan of any preceding or following embodiment/feature/aspect, wherein the permanent magnet motor is a Permanent-Magnet Synchronous Motor (PMSM).
17. The direct drive ceiling fan of any preceding or following embodiment/feature/aspect, wherein the direct drive ceiling fan has a rated torque per volume Kᵥ of from 4.0×10⁶ ft-lb/m³ to 8.0×10⁶ ft-lb/m³.
18. The direct drive ceiling fan of any preceding or following embodiment/feature/aspect, wherein said permanent magnet motor has a Ke of from about 1.35 V/rpm to about 3.2 V/rpm.
19. The direct drive ceiling fan of any preceding or following embodiment/feature/aspect, wherein said stator has an outer diameter of from about 220 mm to about 340 mm, and said rotor has an outer diameter of from about 250 mm to about 370 mm.
20. The direct drive ceiling fan of any preceding or following embodiment/feature/aspect, wherein the permanent magnet motor produces 30 foot-pound of torque and has a speed range of from 75 rpm to 150 rpm.
21. The direct drive ceiling fan of any preceding or following embodiment/feature/aspect, wherein the permanent magnet motor produces 150 foot-pound of torque and has a speed range of from 50 rpm to 100 rpm.
22. The direct drive ceiling fan of any preceding or following embodiment/feature/aspect, wherein the permanent magnet motor produces 50 foot-pound of torque and has a minimum speed of 105 rpm.
23. The direct drive ceiling fan of any preceding or following embodiment/feature/aspect, wherein the permanent magnet motor produces 60 foot-pound of torque and has a minimum speed of 90 rpm.
24. The direct drive ceiling fan of any preceding or following embodiment/feature/aspect, wherein the permanent magnet motor produces 66 foot-pound of torque and has a minimum speed of 80 rpm.
25. The direct drive ceiling fan of any preceding or following embodiment/feature/aspect, wherein the permanent magnet motor produces 70 foot-pound of torque and has a minimum speed of 75 rpm.
26. The direct drive ceiling fan of any preceding or following embodiment/feature/aspect, wherein the permanent magnet motor produces 79 foot-pound of torque and has a minimum speed of 67 rpm.
27. The direct drive ceiling fan of any preceding or following embodiment/feature/aspect, further comprising a bottom housing and top housing to enclose the permanent magnet motor, wherein said bottom housing acts at least in part as a heat sink for the motor controller.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A direct drive ceiling fan comprising:
at least one blade, and a permanent magnet motor as a driving source for the ceiling fan,
wherein the permanent magnet motor is mounted on a shaft and comprises a stator having an axis, a 45 to 90 slot construction, and multiple stator winding coils having a symmetrical winding pattern on said stator; and
a rotor assembly rotatably mounted on the shaft and comprising a circular casing with a periphery, and having a permanent magnet present on the periphery and interacting with the stator winding coils of the stator; wherein said permanent magnet has from 50 to 80 magnetic poles,
and wherein a motor controller is used to energize the stator winding coils, the motor controller changes current of the stator windings to produce magnetic fields required to drive the rotor assembly and the at least one blade.

2. The direct drive ceiling fan of claim 1, wherein each coil of the multiple stator winding coils has from 30 turns to 150 turns per coil.

3. The direct drive ceiling fan of claim 1, wherein the direct drive ceiling fan has an air flow range of from about 50,000 CFM to about 350,000 CFM.

4. The direct drive ceiling fan of claim 1, wherein q is less than 0.5, where
$$q = ( \frac{\# of slots}{\# of magnetic poles} ) \div ( number of Phases )$$

5. The direct drive ceiling fan of claim 1, wherein the permanent magnet motor, when on, operates with zero radial forces (Fx, Fy).

6. The direct drive ceiling fan of claim 1, wherein said winding pattern is . . . /C′A/A′A′/AB′/BB/B′C/C′C′/CA′/AA/A′B/B′B′/BC′/CC/ . . . , where A′, B′, and C′ indicate a reverse in winding direction.

7. The direct drive ceiling fan of claim 1, wherein said winding pattern is . . . /C′A/A′A′/AA/A′B/B′B′/BB/B′C/C′C′/CC/ . . . , where A′, B′, and C′ indicate a reverse in winding direction.

8. The direct drive ceiling fan of claim 1, wherein said winding pattern is . . . /CA′/AB′/BB/B′C′/CA/A′A/AB′/BC′/CC/C′A/A′B/B′B′/BC′/CA′/AA/A′B/B′C/C′C′/ . . . , where A′, B′, and C′ indicate a reverse in winding direction.

9. The direct drive ceiling fan of claim 1, wherein said permanent magnet motor has a slot-pole combination of 48S56P, 60S50P, 60S70P, 72S60P, 84S70P; 45S50P, 54S60P, 63S56P, 63S70P, 72S64P, 72S80P, 81S72P, 90S80P; 54S66P, 72S56P, or 90S70P, where S is slots and P is poles.

10. The direct drive ceiling fan of claim 1, wherein said permanent magnet is a plurality of flat magnets.

11. The direct drive ceiling fan of claim 1, wherein said permanent magnet motor has a minimum Ke of 0.75 V/rpm.

12. The direct drive ceiling fan of claim 1, wherein said permanent magnet motor has a maximum Ke of 3.5 V/rpm.

13. The direct drive ceiling fan of claim 1, wherein said stator has a minimum outer diameter of 220 mm, and/or a minimum rotor outer diameter of 250 mm.

14. The direct drive ceiling fan of claim 1, wherein said permanent magnet motor has a stack length of from about 10 mm to about 50 mm.

15. The direct drive ceiling fan of claim 1, wherein said ceiling fan operates an rpm of from 50 rpm to 180 rpm, a torque of from about 10 ft-lb to about 150 ft-lb, and/or 400 W to 2200 W.

16. The direct drive ceiling fan of claim 1, wherein the permanent magnet motor is a Permanent-Magnet Synchronous Motor (PMSM).

17. The direct drive ceiling fan of claim 1, wherein the direct drive ceiling fan has a rated torque per volume Kᵥ of from 4.0×10⁶ ft-lb/m³ to 8.0×10⁶ ft-lb/m³.

18. The direct drive ceiling fan of claim 1, wherein said permanent magnet motor has a Ke of from about 1.35 V/rpm to about 3.2 V/rpm.

19. The direct drive ceiling fan of claim 1, wherein said stator has an outer diameter of from about 220 mm to about 340 mm, and said rotor has an outer diameter of from about 250 mm to about 370 mm.

20. The direct drive ceiling fan of claim 1, further comprising a bottom housing and top housing to enclose the permanent magnet motor, wherein said bottom housing acts at least in part as a heat sink for the motor controller.
